(19) United States
(12) Patent Application Publication
(10) Pub. No.: US 2020/0272299 A1
(43) Pub. Date: Aug. 27, 2020

(54) INFORMATION PROCESSING APPARATUS, METHOD OF PROCESSING INFORMATION, AND RECORDING MEDIUM

(71) Applicants: Masaaki Kawamura, Kanagawa (JP); Kazuhiro Ikeda, Kanagawa (JP); Norihisa Matsuda, Kanagawa (JP); Fumitoshi Nishina, Kanagawa (JP); Masaki Tsugawa, Kanagawa (JP); Kengo Tanaka, Tokyo (JP); Tetsuya Hirata, Kanagawa (JP)

(72) Inventors: Masaaki Kawamura, Kanagawa (JP); Kazuhiro Ikeda, Kanagawa (JP); Norihisa Matsuda, Kanagawa (JP); Fumitoshi Nishina, Kanagawa (JP); Masaki Tsugawa, Kanagawa (JP); Kengo Tanaka, Tokyo (JP); Tetsuya Hirata, Kanagawa (JP)

(21) Appl. No.: 16/798,822

(22) Filed: Feb. 24, 2020

(30) Foreign Application Priority Data
Feb. 26, 2019 (JP) 2019-033027

(51) Int. Cl. G06F 3/041; G06K 7/10

(52) U.S. Cl. CPC G06F 3/04162; G06K 7/10386; G06F 3/0412

(57) ABSTRACT

An information processing apparatus includes an operation display device, a hardware key input device, a placement detector, and processing circuitry. The operation display device includes a touch panel. The hardware key input device is configured to be placed on the operation display device. The hardware key input device includes a key top having a high dielectric constant for pressing the touch panel. The placement detector is configured to detect placement of the hardware key input device on the operation display device. The processing circuitry is configured to cause a display on the touch panel to transition to a mode enabling a pressing operation using the hardware key input device when the placement detector detects the placement of the hardware key input device.

### CROSS-REFERENCE TO RELATED APPLICATION

This patent application is based on and claims priority pursuant to 35 U.S.C. § 119(a) to Japanese Patent Application No. 2019-033027, filed on Feb. 26, 2019, in the Japan Patent Office, the entire disclosure of which is hereby incorporated by reference herein.

### BACKGROUND

### Technical Field

Aspects of the present disclosure relate to an information processing apparatus, a method of processing information, and a recording medium.

### Related Art

Conventionally, with regard to an operation panel of an information processing apparatus, such as an image forming apparatus, a product with a flattened operation panel and an enlarged display obtained by providing only software keys using a touch panel as well as eliminating hardware keys is becoming more common.

While input operation using software keys has an advantage that, for example, the size of the keys to react can be easily changed by software, an operation error is likely to occur unless the operation is cautiously performed by a user's hand.

In particular, an image forming apparatus such as facsimile (FAX) involves inconvenience that input based on touch typing, which has been easily performed with conventional hardware keys, may not be performed at the time of inputting continuous numbers such as phone numbers, and there has been a demand from users for making input with hardware keys.

In order to meet the demand mentioned above, there has been proposed an image forming apparatus such as FAX in which a numerical pad unit is externally mounted on the side surface of a touch panel. With the image forming apparatus having such a configuration, hardware keys can be added even in a configuration including only a touch panel with only a software numerical pad, whereby the user's demand can be met.

Incidentally, for example, a scheme has been proposed of transmitting static electricity generated by pressing operation performed on hardware keys to an electrostatic capacity type touch panel.

For example, an information processing apparatus has a configuration in which a hard key input device is placed on the electrostatic capacity type touch panel and the static electricity generated by pressing operation performed on the hard key input device is transmitted to the touch panel. The hard key input device mentioned above includes, for example, a battery and a mechanism for generating static electricity by input operation based on pressing of hardware keys.

### SUMMARY

In an aspect of the present disclosure, there is provided an information processing apparatus that includes an operation display device, a hardware key input device, a placement detector, and processing circuitry. The operation display device includes a touch panel. The hardware key input device is configured to be placed on the operation display device. The hardware key input device includes a key top having a high dielectric constant for pressing the touch panel. The placement detector is configured to detect placement of the hardware key input device on the operation display device. The processing circuitry is configured to cause a display on the touch panel to transition to a mode enabling a pressing operation using the hardware key input device when the placement detector detects the placement of the hardware key input device.

In another aspect of the present disclosure, there is provided a method of processing information used for an information processing apparatus. The information processing apparatus includes an operation display device including a touch panel; a hardware key input device configured to be placed on the operation display device, the hardware key input device including a key top having a high dielectric constant for pressing the touch panel; and a placement detector configured to detect placement of the hardware key input device on the touch panel. The method includes detecting the placement of the hardware key input device using the placement detector and causing a display on the touch panel to transition to a mode enabling a pressing operation using the hardware key input device when the placement detector detects the placement of the hardware key input device.

In still another aspect of the present disclosure, there is provided a non-transitory recording medium storing computer readable code for causing an information processing apparatus to execute a method of processing information. The information processing apparatus includes an operation display device including a touch panel; a hardware key input device configured to be placed on the operation display device, the hardware key input device including a key top having a high dielectric constant for pressing the touch panel; and a placement detector configured to detect placement of the hardware key input device on the touch panel. The method includes detecting the placement of the hardware key input device using the placement detector and causing a display on the touch panel to transition to a mode enabling a pressing operation using the hardware key input device.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating a schematic configuration of an information processing apparatus according to a first embodiment;

FIG. 2A is a front view of a hardware key input device;

FIG. 2B is a partial cross-sectional view of the hardware key input device;

FIG. 3 is a block diagram illustrating a schematic configuration of an apparatus body and a hardware key input device included in an information processing apparatus according to a second embodiment;

FIG. 4 is a flowchart illustrating schematic process content in the case where a hardware key input device is placed on an operation display device;

FIG. 5A is a front view illustrating a display mode of a touch panel before the hardware key input device is placed on the operation display device;

FIG. 5B is a front view of the hardware key input device;

FIG. 6 is a front view illustrating a display mode of the touch panel after the hardware key input device is placed on the operation display device;

FIG. 7 is a flowchart illustrating detailed process operation in the case where the hardware key input device is placed on the operation display device when radiofrequency identification (RFID) is used as a placement detector;

FIG. 8 is a flowchart illustrating detailed process operation in the case where the hardware key input device placed on the operation display device is removed when RFID is used as a placement detector;

FIG. 9 is an explanatory diagram illustrating a display mode according to an exemplary touch panel before the hardware key input device is placed on the operation display device;

FIG. 10 is an explanatory diagram illustrating a display mode according to another exemplary touch panel before the hardware key input device is placed on the operation display device;

FIG. 11A is a front view of an operation display device according to another example;

FIG. 11B is a front view of a hardware key input device according to another example; and

FIG. 12 is a flowchart illustrating process operation in the case where RFID is used as a placement detector and a plurality of types of hardware key input devices is selectively placed on the operation display device.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

In the scheme of externally attaching a numerical pad unit on a side surface of a touch panel as described above, the touch panel protrudes outward at the time of being attached. In addition, the side part of the touch panel may not be usable due to the externally attached numerical pad unit, whereby an input interface or the like may not be disposed on the side part of the touch panel.

Meanwhile, in a hard key input device including, for example, a battery and a mechanism for generating static electricity, the touch panel that can be operated is limited to the electrostatic capacity type, and a resistive touch panel may not be supported.

Furthermore, although the side part of the touch panel can be free, components such as a battery and a mechanism for generating static electricity increase, whereby the complexity of the mechanism and the cost may increase and the risk of failure may also increase.

As described below, according to at least one embodiment of the present disclosure, an input interface of hardware keys can be easily added with a simple configuration and the risk of failure can be reduced without restricting the use of a side part of an operation display unit.

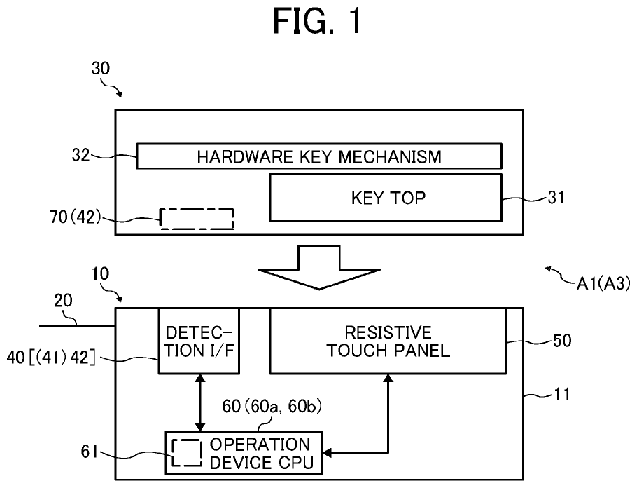

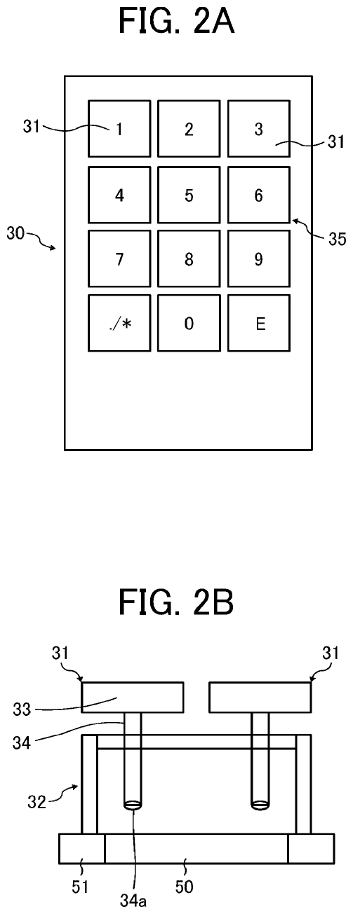

Hereinafter, an information processing apparatus according to an embodiment of the present disclosure will be described with reference to the accompanying drawings. FIG. 1 is a block diagram illustrating a schematic configuration of an information processing apparatus according to a first embodiment, FIG. 2A is a front view of a hardware key input device, and FIG. 2B is a partial cross-sectional view of the hardware key input device. Note that an image forming apparatus that is an information processing apparatus including a touch panel and a keyboard will be described as an example in the present embodiment.

As illustrated in FIG. 1, an image forming apparatus A1 according to the first embodiment includes an apparatus body 20 on which an operation display device 10 according to an example is disposed, and a hardware key input device (hereinafter abbreviated as “hard key input device”) 30.

The operation display device 10 includes a detection interface (hereinafter abbreviated as “detection I/F”) 40, a resistive touch panel (hereinafter abbreviated as “touch panel”) 50, and an operation device CPU 60, which are disposed in a casing 11. The touch panel 50 is supported by the casing 11 with a frame 51 (see FIGS. 2A and 2B) surrounding the touch panel.

The detection I/F 40 according to the present embodiment is a sensor for detecting that the hard key input device 30 is placed on the operation display device 10. The detection I/F 40 is a placement detector for detecting placement of the hard key input device 30 on the operation display device 10.

In the operation device central processing unit (CPU) 60, each of the detection I/F 40 and the touch panel 50 is appropriately connected to an input/output port (not illustrated) of the operation device CPU 60.

The operation device CPU 60 stores a required information processing program in a built-in memory 61. The information processing program according to the present embodiment has content including a step of detecting placement of the hard key input device 30 using the detection I/F 40, and a step of transitioning display of the touch panel 50 to a mode in which a pressing operation using the hard key input device 30 can be performed.

The operation device CPU 60 exhibits the following function with the information processing program being executed. A function of transitioning the display of the touch panel 50 to a mode in which a pressing operation using the hard key input device 30 can be performed when placement of the hard key input device 30 is detected by the detection I/F (placement detector) 40. This function is referred to as a “display mode transition unit 60a”.

The “mode in which a pressing operation using the hard key input device 30 placed on the operation display device 10 can be performed” is as follows. That is, it indicates a mode in which a user can press key tops 31 (see FIGS. 2A and 2B) of the hard key input device 30, and details of the mode will be described later.

As illustrated in FIG. 2A, the hard key input device 30 includes a numerical pad 35 including a plurality of key tops 31, and a hardware key mechanism 32 (see FIG. 2B) that supports those key tops 31, and is a separate body detachable from the operation display device 10.

The key top 31 is made of a material having a high dielectric constant comparable to the dielectric constant of a user's finger, and is provided not to damage the touch panel 50. The key top 31 is provided integrally with a cover 33 at the upper end of a shaft 34 in the drawing. When the hard key input device 30 is brought into contact with the frame 51 of the operation display device 10, the hardware key mechanism 32 elastically supports a contact end 34a of the shaft 34 to be separated from the touch panel 50.

The phrase “not to damage the touch panel 50” includes the hardness of the material forming the key top 31, formation of the contact end 34a to contact the touch panel 50 with a required curved surface, and the like.

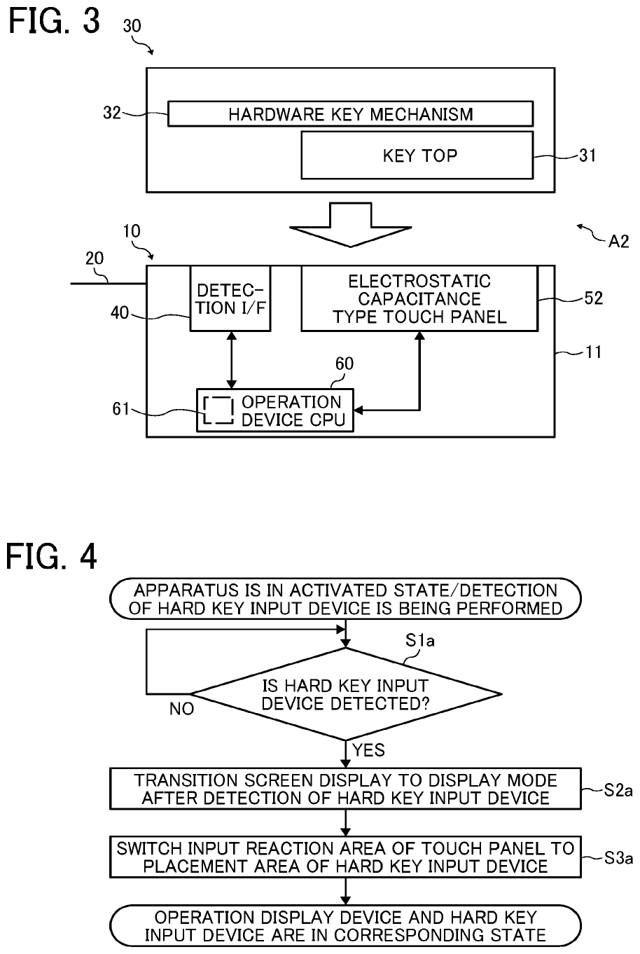

FIG. 3 is a block diagram illustrating a schematic configuration of an apparatus body and a hard key input device included in an image forming apparatus according to a second embodiment. Since an image forming apparatus A2 according to the second embodiment illustrated in FIG. 3 has a configuration similar to the configuration of the image forming apparatus A1 described above except for a touch panel 52, in FIG. 3, components same as or equivalent to the components described above with reference to FIG. 1 or the like will be denoted by the same reference signs to omit duplicate descriptions, and only differences will be described.

The touch panel 52 illustrated in FIG. 3 is of an electrostatic capacity type, which is different from the resistive touch panel described above in that a position is detected by a change in the electrostatic capacity being detected between a conductive film and a user's fingertip. As described above, since the key top 31 of the hard key input device 30 according to the present embodiment has a high dielectric constant, operation can be performed using the electrostatic capacity type touch panel 52.

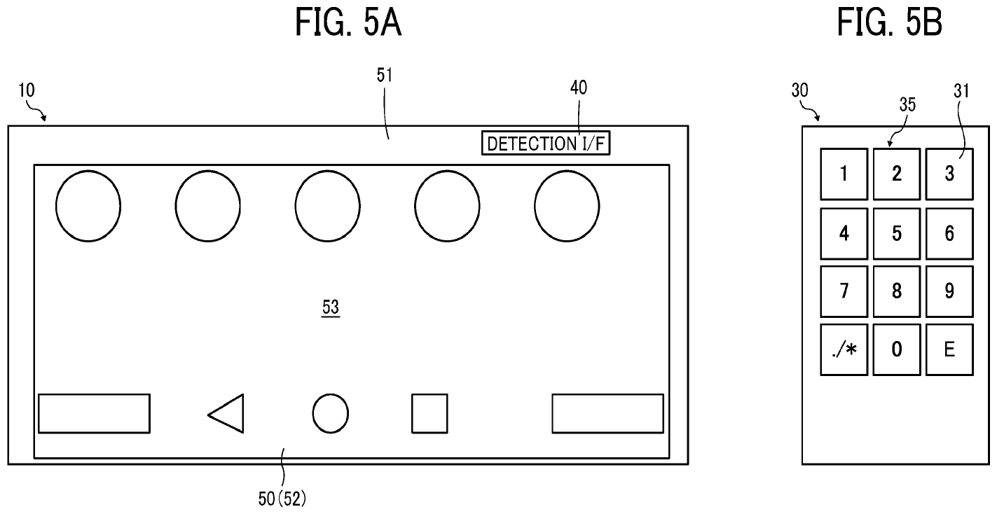

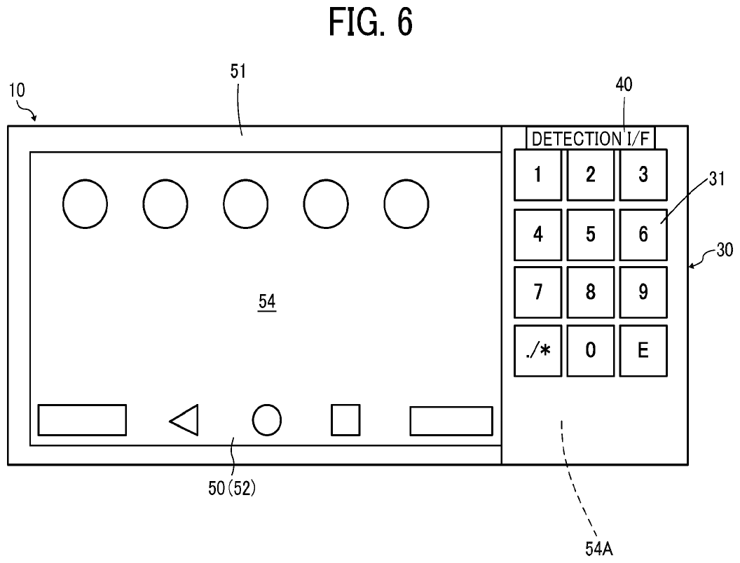

FIG. 4 is a flowchart illustrating schematic process content in the case where the hard key input device 30 is placed on the operation display device 10. FIG. 5A is a front view illustrating a display mode of the touch panel 50 (52) before the hard key input device 30 is placed on the operation display device 10, and FIG. 5B is a front view of the hard key input device 30. FIG. 6 is a front view illustrating a display mode of the touch panel 50 (52) after the hard key input device 30 is placed on the operation display device 10.

A method of processing information according to the present embodiment is used for an information processing apparatus having the configuration described above, and when placement of the hard key input device 30 is detected by the placement detector 40, display of the touch panel 50 (52) transitions to a mode in which pressing operation using the hard key input device 30 can be performed.

Step 1 (abbreviated as “S1a” in FIG. 4; the same applies hereinafter): If placement of the hard key input device 30 is detected in the state where the image forming apparatus A1 (A2) is activated and waiting for detection of the hard key input device 30, the process proceeds to step 2 (S2a).

Step 2 (S2a): The display on the touch panel 50 (52) transitions from a display mode of a key display area 53 (see FIG. 5A) before the hard key input device 30 is placed on the operation display device 10 to a display mode of a key display area 54 (see FIG. 6) after the hard key input device 30 is placed on the operation display device 10.

Specifically, as illustrated in FIG. 5A, it is in the mode where the key display area 53 is displayed on the entire screen of the touch panel 50 (52) before the hard key input device 30 is placed on the operation display device 10.

The “display mode before the hard key input device 30 is placed on the operation display device 10” indicates a display mode in which only input operation using a software key displayed on the touch panel 50 (52) can be performed. In this display mode, input operation using the hard key input device 30 cannot be performed.

When placement of the hard key input device 30 on the operation display device 10 is detected, the key display area 53 transitions to the key display area 54 diminished to the left side of the screen of the touch panel 50 (52) in the drawing. Along with this transition, it enters a display mode in which a placement area 54A corresponding to the size of the hard key input device 30 is formed on the right side of the screen in the drawing.

Step 3 (S3a): The input reaction area of the touch panel 50 (52) is switched to the placement area 54A. As a result, the operation display device 10 and the hard key input device 30 enters a corresponding state, and input operation using the hard key input device 30 can be performed.

An image forming apparatus A3 (see FIG. 1) according to a third embodiment employs what is called a radio frequency identifier (RFID) as a placement detector. Note that RFID refers to a technique or general technology of exchanging information by short-range wireless communication using an electromagnetic field, radio waves, or the like from an RF tag in which ID information is embedded.

In the image forming apparatus A3 according to the present embodiment, while an RF tag 70 (see FIG. 1) is disposed on each hard key input device 30 to discriminate between a plurality of types of hard key input devices 30, a reading device (detection I/F) 41 is disposed on the side of the apparatus body 20. The RF tag 70 includes, as ID information, type discrimination information for discriminating each of the plurality of types of hard key input devices 30.

In the present embodiment, the RF tag 70 and the reading device (detection I/F) 41 constitute a placement detector 42 for detecting placement of the hard key input device 30 on the operation display device 10.

The memory 61 of the operation display device 10 stores type discrimination information for specifying the hard key input device 30 allowed to be placed on the operation display device 10 in advance.

In the present embodiment, the operation device CPU 60 involves a discrimination function (to be referred to as a “type discriminator 60b”) of causing the reading device 41 to read the type discrimination information of the hard key input device 30 placed on the operation display device 10 and discriminating a type of the hard key input device 30 on the basis of the read type discrimination information. The type discriminator 60b performs discrimination by comparing and referring to the type discrimination information stored in the memory 61 and the type discrimination information recorded in the RF tag 70.

The display mode transition unit 60a according to the present embodiment allows transition from the display mode (see FIG. 5A) before the hard key input device 30 is placed on the operation display device 10 to the display mode (see FIG. 6) after the hard key input device 30 is placed on the operation display device 10 only when the type discriminator 60b determines that the hard key input device 30 is of a type set in advance.

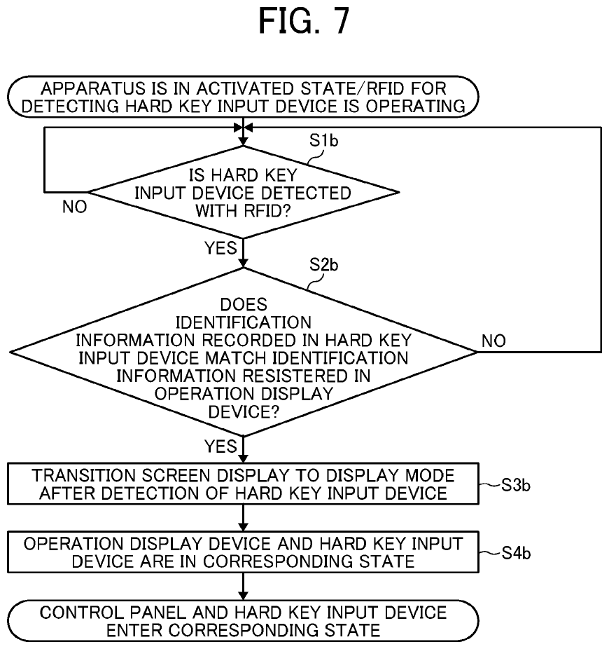

FIG. 7 is a flowchart illustrating detailed process operation in the case where the hard key input device 30 is placed on the operation display device 10 when the RFID is used as a placement detector. Step 1 (abbreviated as “S1b” in FIG. 7; the same applies hereinafter): If the hard key input device 30 is detected in the state where the image forming apparatus A3 is activated and placement of the hard key input device 30 is being detected, the process proceeds to step 2 (S2b).

Step 2 (S2b): The type identification information stored in the memory 61 is compared with the type discrimination information stored in the RF tag 70 of the placed hard key input device 30, and if the information is confirmed to match with each other, the process proceeds to step 3 (S3b).

Step 3 (S3b): The display on the touch panel 50 (52) transitions from the display mode of the key display area 53 (see FIG. 5A) before the hard key input device 30 is placed on the operation display device 10 to the display mode of the key display area 54 (see FIG. 6) after the hard key input device 30 is placed on the operation display device 10.

Step 4 (S4b): The input reaction area of the touch panel 50 (52) is switched to the placement area 54A. As a result, the operation display device 10 and the hard key input device 30 enters a corresponding state, and input operation using the hard key input device 30 can be performed.

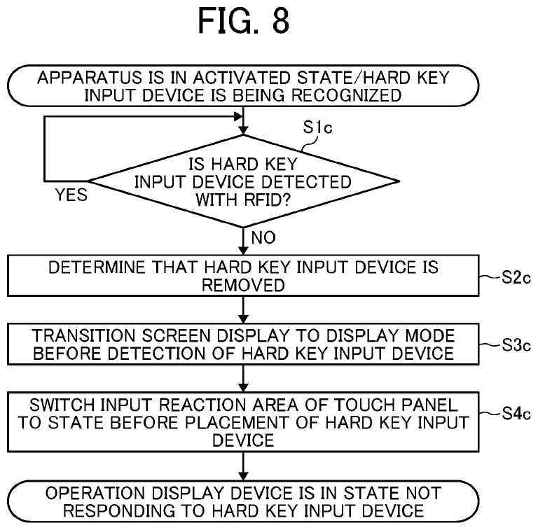

FIG. 8 is a flowchart illustrating detailed process operation in the case where the hard key input device 30 placed on the operation display device 10 is removed when the RFID is used as the placement detector.

In the image forming apparatus according to the present embodiment, the display mode transition unit 60a has a function of causing the display on the touch panel 50 (52) to transition to a display mode in which no pressing operation is performed using the hard key input device 30 when the hard key input device 30 placed on the operation display device 10 is not detected.

Step 1 (abbreviated as “S1c” in FIG. 8; the same applies hereinafter): When the type identification information of the hard key input device 30 placed on the operation display device 10 is no longer detected, the process proceeds to step 2 (S2c).

Step 2 (S2c): The hard key input device 30 is determined to be removed from the operation display device 10, and the process proceeds to step 3 (S3c).

Step 3 (S3c): The display on the touch panel 50 (52) is caused to transition from the display mode of the key display area 54 (see FIG. 6) after the hard key input device 30 is placed on the operation display device 10 to the display mode of the key display area 53 (see FIG. 5A) before the hard key input device 30 is placed on the operation display device 10.

Step 4 (S4c): The input reaction area of the touch panel 50 (52) is switched to the state before the hard key input device 30 is placed on the operation display device 10. As a result, input operation using the hard key input device 30 does not react.

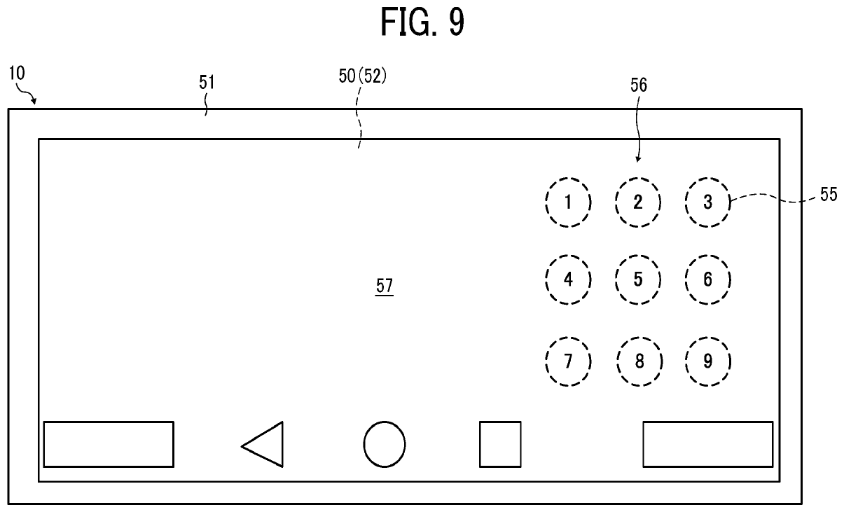

FIG. 9 is an explanatory diagram illustrating a display mode according to an example of the touch panel 50 (52) before the hard key input device 30 is placed on the operation display device 10. In the image forming apparatus according to the present embodiment, the placement detector for detecting placement of the hard key input device 30 on the operation display device 10 is implemented by software.

That is, the placement of the hard key input device 30 is detected by preset placement detection information being compared with input information input from the hard key input device 30. As a result, the detection I/F described above does not need to be disposed, and a specific example will be described below.

In a display mode 57 according to the example illustrated in FIG. 9, a numerical pad 56 including software keys 55 from “1” to “9” is displayed in the right area of the touch panel 50 (52) in the drawing. The software keys 55 are arranged to face the respective key tops 31 of the hard key input device 30 when the hard key input device 30 described above is placed on the operation display device 10.

In the present embodiment, for example, a permutation combination (placement detection information) of four numeric digits including “1”, “4”, “7”, and “8” is stored (registered) in the memory 61 in advance via the software keys 55 mentioned above. At this time, the permutation combination of numbers is a combination not to be pressed when the hard key input device 30 is not placed.

Subsequently, the four numeric digits pressed through the hard key input device 30 placed on the operation display device 10 is determined whether or not to match the numerical sequence input through the software keys 55. Then, if the pressed four numeric digits are determined to match, input operation using the hard key input device 30 placed on the operation display device 10 is permitted.

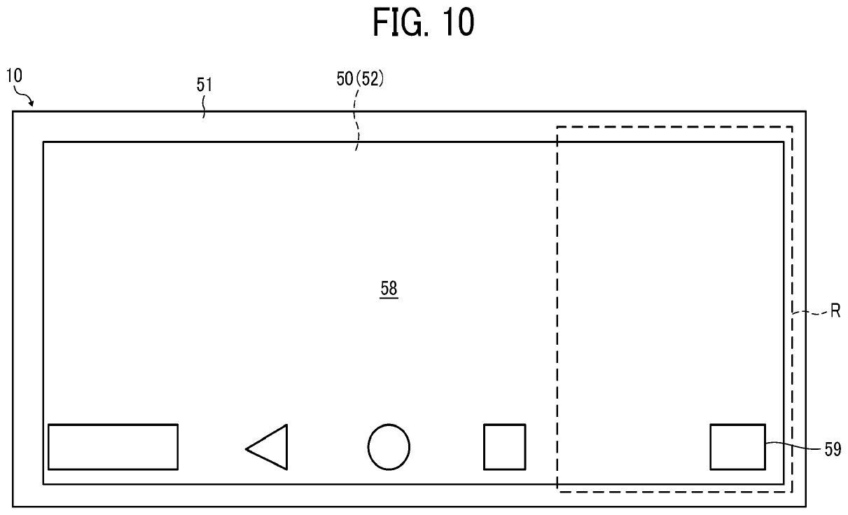

FIG. 10 is an explanatory diagram illustrating a display mode according to another example of the touch panel 50 (52) before the hard key input device 30 is placed on the operation display device 10. In the image forming apparatus according to the present embodiment, an input operation canceling software key 59 for canceling the input operation using the hard key input device 30 is displayed on the touch panel 50 (52).

That is, when the hard key input device 30 is placed on the operation display device 10, a display area R of the touch panel 50 (52) hidden by the hard key input device 30 displays the input operation canceling software key 59.

Specifically, the input operation canceling software key 59 is displayed at a position not corresponding to the software keys 55 of “1” to “9” in the display area R.

A timing for displaying the input operation canceling software key 59 is, for example, when placement of the hard key input device 30 on the operation display device 10 is detected. Accordingly, while the hard key input device 30 is being placed, the input operation canceling software key 59 is hidden and input cannot be cancelled. Input operation using the hard key input device 30 can be cancelled with the input operation canceling software key 59 that appears when the hard key input device 30 is removed being pressed.

The display mode after the hard key input device 30 is placed on the operation display device 10 illustrated in FIG. 10 may transition to, for example, the display mode (see FIG. 5A) before the hard key input device 30 is placed on the operation display device 10 by the input operation canceling software key 59 being pressed.

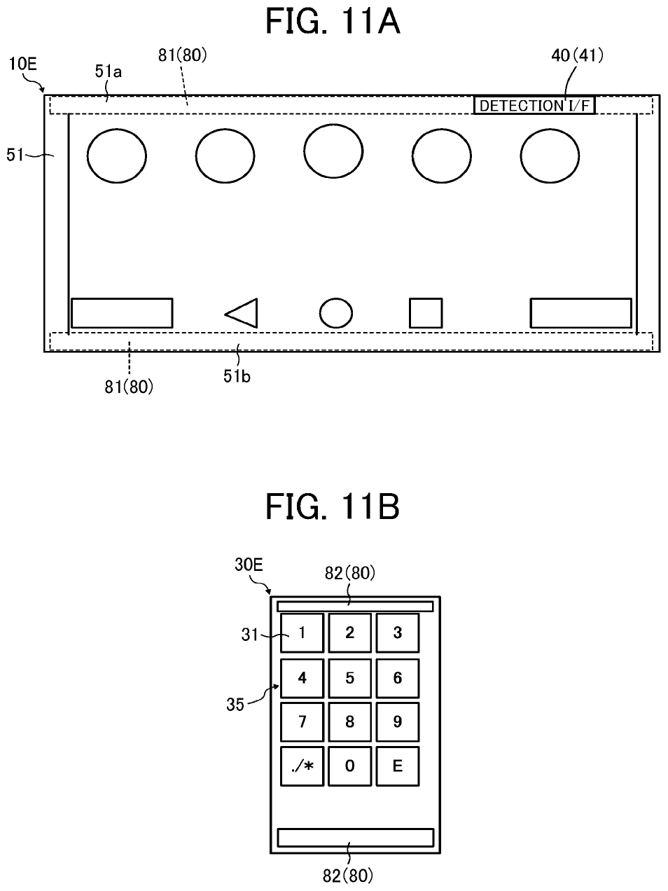

FIG. 11A is a front view of a operation display device according to another example, and FIG. 11B is a front view of a hard key input device according to another example. Note that the operation display device and the hard key input device according to the other example illustrated in FIGS. 11A and 11B have configurations substantially similar to those described in the image forming apparatus A1. Therefore, in the drawing, the same or equivalent components as those described above are denoted by the same reference signs to omit duplicate descriptions, and only differences will be described.

The image forming apparatus according to the present embodiment includes a magnetic force securing device 80 that places and secures, by magnetic force, a hard key input device 30E and a operation display device 10E according to another example.

The magnetic force securing device 80 includes metal plates 81 and 81 disposed on the operation display device 10E, and magnet plates 82 and 82 disposed on the hard key input device 30A. The metal plates 81 and 81 are laterally formed on the back surfaces of laterally long frame members 51a and 51b of the frame 51 surrounding the touch panel 50 (52) in the drawing. The magnet plates 82 and 82 are formed as a pair of laterally long plates in the drawing at positions facing the metal plates 81 and 81, respectively. With the configuration described above, the hard key input device 30E can be easily placed and secured onto the operation display device 10E.

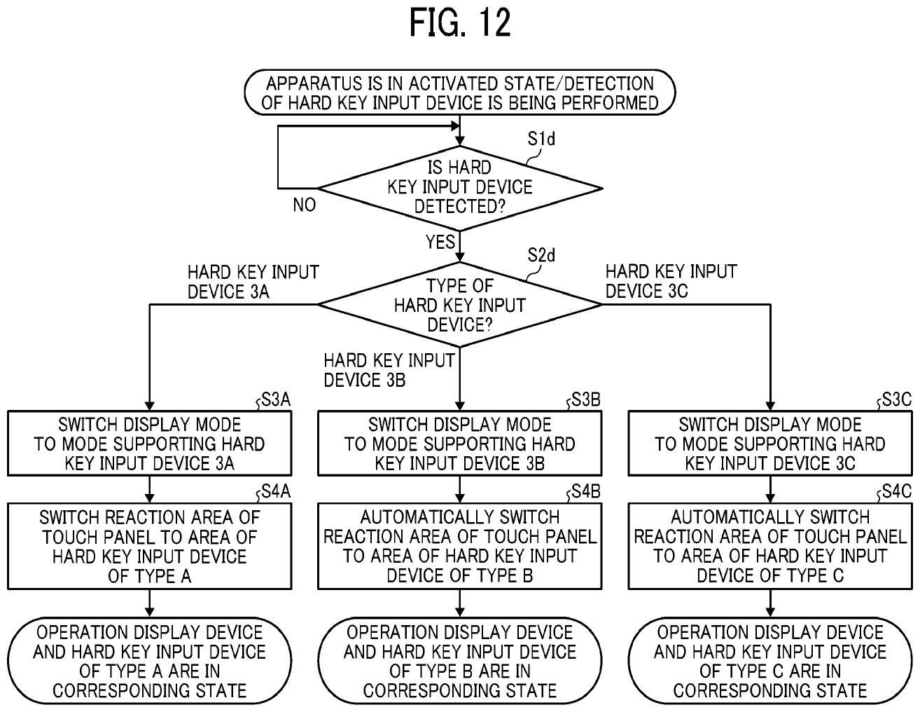

FIG. 12 is a flowchart illustrating process operation in the case where the RFID is used as a placement detector and a plurality of types of hardware key input devices is selectively placed on the operation display device 10. Although FIG. 12 illustrates an exemplary case where three types of hard key input devices 30A, 30B, and 30C are selectively placed on the operation display device 10, it goes without saying that the present disclosure is not limited to this case.

In the image forming apparatus according to the present embodiment, the display mode transition unit 60a described above has the following function. That is, there is given a function of causing the display on the touch panel 50 (52) to transition to a mode in which pressing operation using the hard key input device 30A (30B, 30C) can be performed when placement of the hard key input device 30A (30B, 30C) is detected by the RFID.

In other words, the display on the touch panel 50 (52) is caused to transition from the mode before the hard key input device 30A (30B, 30C) is placed on the operation display device 10 to the mode after the hard key input device 30A (30B, 30C) is placed on the operation display device 10.

Step 1 (abbreviated as “S1d” in FIG. 12; the same applies hereinafter): If placement of any of the hard key input devices 30A, 30B, and 30C is detected in the state where the hard key input devices 30A, 30B, and 30C are being detected in the image forming apparatus, the process proceeds to step 2 (S2d).

Step 2 (S2d): A type of the placed hard key input device 30A, 30B, or 30C is determined, and the process proceeds to step 3A (S3A) in the case of the hard key input device 30A, to step 3B (S3B) in the case of the hard key input device 30B, or to step 3C (S3C) in the case of the hard key input device 30C.

Step 3A (S3A): The display on the touch panel 50 (52) is caused to transition from the mode before the hard key input device 30A is placed on the operation display device 10 to the mode in which pressing operation using the hard key input device 30A can be performed.

Step 4A (S4A): The input reaction area of the touch panel 50 (52) is switched to the placement area of the hard key input device 30A. As a result, input operation using the placed hard key input device 30A can be performed.

Similarly, the process proceeds to step 3B (S3B) in the case of the hard key input device 30B in step 2 (S2d), and to step 3C (S3C) in the case of the hard key input device 30C.

As a result, input operation can be performed according to the type of the hard key input device placed on the operation display device 10.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing apparatus comprising:
an operation display device including a touch panel;
a hardware key input device configured to be placed on the operation display device, the hardware key input device including a key top having a high dielectric constant for pressing the touch panel;
a placement detector configured to detect placement of the hardware key input device on the operation display device; and
processing circuitry configured to cause a display on the touch panel to transition to a mode enabling a pressing operation using the hardware key input device when the placement detector detects the placement of the hardware key input device.

2. The information processing apparatus according to claim 1,
wherein a contact end of the key top configured to contact the touch panel is formed not to damage the touch panel.

3. The information processing apparatus according to claim 1,
wherein the placement detector includes a radio frequency identifier (RFID).

4. The information processing apparatus according to claim 1,
wherein the processing circuitry causes the display on the touch panel to transition to a display mode disabling the pressing operation using the hardware key input device when the hardware key input device placed on the operation display device is not detected by the placement detector.

5. The information processing apparatus according to claim 1,
wherein the placement detector checks and discriminates input information input from the hardware key input device and preset placement detection information to detect the placement of the hardware key input device.

6. The information processing apparatus according to claim 1,
wherein the touch panel is configured to display an input operation canceling software key for canceling input operation from the hardware key input device, in a screen area hidden by the hardware key input device when the hardware key input device is placed on the operation display device.

7. The information processing apparatus according to claim 1, further comprising a magnetic force securing device configured to secure the hardware key input device placed on the operation display device by magnetic force.

8. The information processing apparatus according to claim 1,
wherein the processing circuitry discriminates a plurality of types of hardware key input devices different from each other and display a mode enabling a pressing operation using one of the plurality of types of hardware key input devices discriminated by the processing circuitry.

9. A method of processing information used for an information processing apparatus including an operation display device including a touch panel; a hardware key input device configured to be placed on the operation display device, the hardware key input device including a key top having a high dielectric constant for pressing the touch panel; and a placement detector configured to detect placement of the hardware key input device on the touch panel, the method comprising:
detecting the placement of the hardware key input device using the placement detector; and
causing a display on the touch panel to transition to a mode enabling a pressing operation using the hardware key input device when the placement detector detects the placement of the hardware key input device.

10. The method according to claim 9,
wherein the transitioning causes the display on the touch panel to transition to a display mode disabling the pressing operation using the hardware key input device when the hardware key input device placed on the operation display device is not detected by the placement detector.

11. The method according to claim 9,
wherein the detecting checks and discriminates input information input from the hardware key input device and preset placement detection information, using the hardware key input device, to detect the placement of the hardware key input device.

12. The method according to claim 9, further comprising displaying an input operation canceling software key for canceling input operation from the hardware key input device, in a screen area of the touch panel hidden by the hardware key input device when the hardware key input device is placed on the operation display device.

13. The method according to claim 9, further comprising:
discriminating a plurality of types of hardware key input devices different from each other; and
displaying a mode enabling a pressing operation using one of the plurality of hardware key input devices discriminated by the discriminating.

14. A non-transitory recording medium storing computer readable code for causing an information processing apparatus to execute a method of processing information, the information processing apparatus including an operation display device including a touch panel; a hardware key input device configured to be placed on the operation display device, the hardware key input device including a key top having a high dielectric constant for pressing the touch panel; and a placement detector configured to detect placement of the hardware key input device on the touch panel, the method comprising:
detecting the placement of the hardware key input device using the placement detector; and
causing a display on the touch panel to transition to a mode enabling a pressing operation using the hardware key input device.
